(19) United States
(12) Patent Application Publication
(10) Pub. No.: US 2003/0154866 A1
(43) Pub. Date: Aug. 21, 2003

(54) Uniform heat disseminating cooking vessel

(76) Inventor: Amar Dev Amar, Warren, NJ (US)

Correspondence Address: A. D. Amar, Ph.D., 11 Pinewood Lane, Warren, NJ, 07059, US

(21) Appl. No.: 10/075,892

(22) Filed: Feb. 15, 2002

(51) Int. Cl. A47J 37/10

(52) U.S. Cl. 99/422

(57) ABSTRACT

A cooking vessel has a segment of a perfect hollow sphere as food-holding chamber integrated with a cylindrical shaped housing with breathing vents along its perimeter. This chamber is configured allowing accumulation of food on the food-holding chamber in proportion to the amount of heat being received by that particular spot. The cylindrical housing incorporates at its base a flat ring to stabilize the vessel's position when it rests on a flat surface. A removable cover on the chamber defines its cooking space. To accommodate various amounts of food to be cooked in the same chamber, the vessel has different-sized removable covers each with a definite diameter allowing most common household amounts. This way, the vessel adjusts steam and flue gas trapping space that is responsive to different cooking amounts and allows the cook some control over pressure in the chamber.

### BACKGROUND OF THE INVENTION

The invention of Uniform Heat Disseminating Cooking Vessel, subject of this application, has been undertaken to address two sets of drawbacks prevalent in many household-cooking vessels. These drawbacks are: (A) The Problem of Heat Dissemination, and (B) Rounded-Bottom Vessel Problem. Their detailed explanation follows.

(A) The Problem of Heat Dissemination

Cooking in traditional cooking vessels, such as pots, pans, and even in many flat-bottom woks is what may be call flat-surface cooking, since the food rests on a flat surface, which, on its opposite surface, is receiving flames from the heat source. Flat-surface cooking has a number of set characteristics that affect the quality of food being cooked:

i) All kinds of cooking with oil in a flat-surface cooking vessel can be difficult to manage as the oil spreads thinly to cover the whole of its flat surface. Under these conditions, oil can get overheated, and crack changing its chemistry which can negatively impact the taste and nutritional value of the food being cooked in a flat-surface cooking vessel.

ii) Pieces of foods, in specific the lumpy ones, being cooked on a flat surface tend to pull apart from each other, resulting in decreased natural juices, flavors, and tenderness. If these pieces remain pulled away from each other while being cooked, the cooked food will be less tender and moist, and may turn out to be unevenly cooked.

iii) Because of the air circulating in large pockets surrounding the food pieces not lying snug, tight next to each other while being cooked, flat-surface cooking vessels will have a larger number of cold pockets in it, especially if the vessel is not almost filled with the food. This can result in an increased cooking time.

In an attempt to avoid the above given drawbacks inherent in flat-surface cooking vessels, cook attends to the food regularly and continues to stir the food attempting to gather its pieces together. However, in spite of this, the cook may not succeed in cooking food that has locked-in natural flavors, is tender, and evenly cooked.

In addition to the above, flat-surface cooking vessels have a problem with the dissemination of heat from its source in the stove to the food being cooked in it. It is so because typical heating devices, such as household gas stoves, tend to disseminate heat that is concentrated in the center and decreases with the increase in distance from it. Nevertheless, a flat-surface cooking vessel holds food evenly on it—having equal thickness of food layers throughout its cooking surface. This causes the food laying closer to the center of the vessel to get more heat, whereas, food laying away gets less, although the amount of food may be about equal. This condition can require constant stirring. If left alone, the result could be unevenly cooked food.

(B) The Rounded-Bottom Vessel Problem

To redress some aspects of the first problem, there is wok—a cooking vessel with some kind of rounded bottom. In spite of its ability to cook food better, woks have not become popular in household cooking. In my observation, three reasons explain why woks have not become popular. The first two of these have to do with the fundamental geometry of the bottom of woks.

i) Because of their rounded bottom, woks are not convenient to handle. The bottom makes it extremely difficult to rest woks on surfaces commonly available in standard household kitchens.

ii) Woks do not have appearance that conforms to the rest of the standard household cooking vessels.

iii) The third important observation that I made relating to woks is that, although wok does a better job than flat-surface cooking vessels in disseminating heat, it may not uniformly transmit heat from the stove to the food being cooked in it.

These shortcomings of household pots, pans, and woks, made me realize the need of designing a cooking vessel that will overcome them. The invention subject of this application addresses this need.

### BRIEF SUMMARY OF THE INVENTION

To correct the problems associated to flat-surface cooking vessels as stated in the Background of the Invention, a new cooking vessel is invented. The food-holding chamber of this vessel is a segment of a hollow perfect sphere with a radius between 220-270 mm subtended at its center. This way, bottom of the vessel receives heat from the stove in proportion to the amount of food that would naturally lie on it due to the configuration designed for it.

### BRIEF DESCRIPTION OF THE SEVERAL VIEWS OF THE DRAWINGS

To explain this invention, seven drawings are given on four sheets being attached herewith. A brief description on each one of them is given below:

FIG. 1 is a front view, partly schematic, of a burner of a typical household gas stove, surrounded by a cross-section of a common grill, showing a conical envelope of flames from it.

FIG. 2 shows geometry explaining a specific contour of the bottom of a cooking vessel to assure uniform dissemination of heat from the burner flames to the food contained in the vessel.

FIG. 3 shows an elevation of complete Uniform Heat Disseminating Cooking Vessel I designed incorporating the configuration arrived at in FIG. 2.

FIG. 4 depicts a bottom view of Uniform Heat Disseminating Cooking Vessel accommodating configuration of FIG. 2, showing breathing vents along its perimeter.

FIG. 5 is a top view of Uniform Heat Disseminating Cooking Vessel assembly. A plane I-I runs through its center to get a cross-sectional view to explain its function.

FIG. 6 is a cross-sectional view at plane I-I of Uniform Heat Disseminating Cooking Vessel explaining its design and construction.

FIG. 6A is an enlarged detail of a point of the assembly where various parts and pieces of Uniform Heat Disseminating Cooking Vessel meet.

### DETAILED DESCRIPTION OF THE INVENTION

This vessel has been designed to eliminate the problems of heat dissemination and rounded-bottom stability prevalent in household cooking pots, pans, and woks. This vessel has its bottom shaped as a segment of a perfect hollow sphere with its geometry so defined that it facilitates uniform heat dissemination from the stove to the food being cooked in it while at the same time conforming to the appearance of standard household cooking vessels. The food-holding chamber of this vessel is very closely related to woks, however, without their usual shortcomings.

Wok, an ancient Asian cooking vessel, in its original design had been suited to large wood-burning open hearths or coal-fired furnaces. Nevertheless, due to the unsuitability of its ancient design to household gas-fired or electric stoves, woks have not become very popular in household cooking. Another reason for its low popularity has been the lack of its stability while resting on flat-surfaces, common in contemporary household kitchens. Its rounded base is difficult to rest it; and, usually, the rings used to rest it are too crude and inconvenient.

Through experiments, I have observed the following characteristics relevant to the use of cooking vessels on gas burners of household stoves:

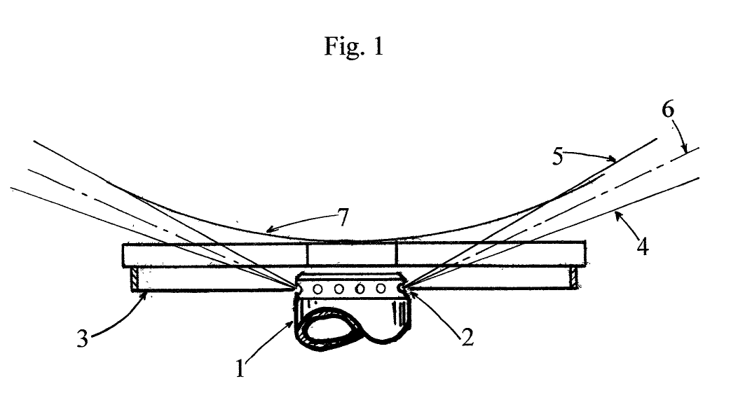

Observation 1: Most gas flames are released from their household stove burners in a 20° to 30° wide conical envelope subtended at each orifice of the burner. This envelope has an average inclination of about 25° to a horizontal line running through the orifices of the burner. This is detailed in FIG. 1. In this figure, burner 1 has a number of orifices 2 that lie along its perimeter at which gas is lighted. Burner 1 is surrounded by a grill 3 on which cooking utensils are placed while cooking. The flame from each of these orifices comes out in a conical shaped envelope defined by limits 4 and 5 given in FIG. 1, where 4 is the lower limit and 5 the upper limit of this envelop. The center of this envelope is represented by line 6 in this figure. A configuration defined by curve 7 in FIG. 1 should allow these flame vectors to continue their natural lift without any hinder.

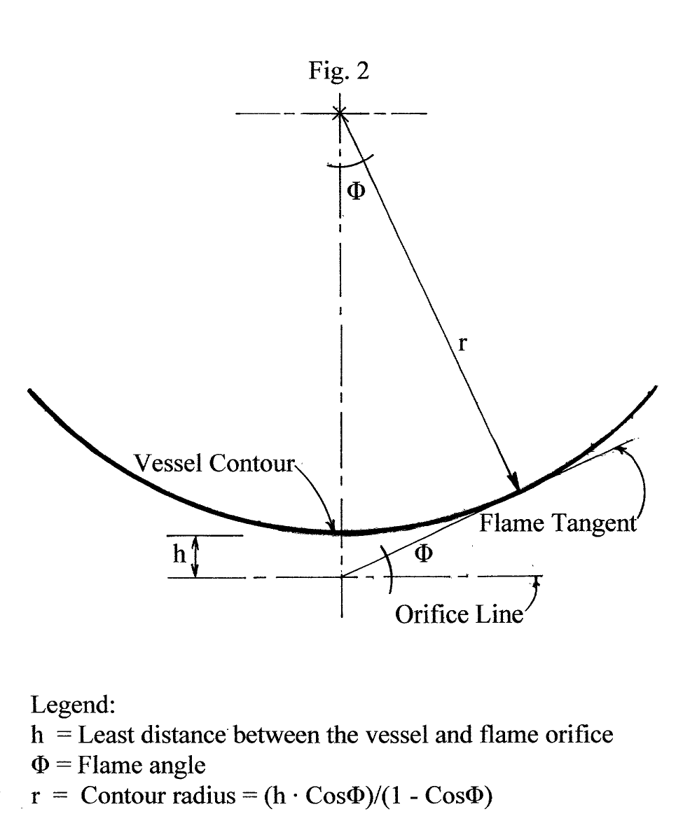

Observation 2: Inherent in the design of most household gas stoves is that a horizontal plane containing all flame orifices is parallel and about 25 mm away from the plane on which most cooking vessels rest when laid on a stove. FIG. 2 further illustrates this observation. Orifice Line in FIG. 2 denotes position of the horizontal plane containing all orifices. The bottom of the Vessel Contour represents the plane on which cooking vessels rest when laying on such stoves. This distance, denoted by h in FIG. 2, is observed to be ˜25 mm.

Given the two observations above, I found it exciting to design a cooking vessel that will allow for optimal dissemination of heat from its source. The first step in doing this required calculating contour of the vessel that will achieve this uniform dissemination of heat. FIG. 2 summarizes the mathematics behind these calculations. The burner flames rise at an angle φ to the Orifice Line. For uniform dissemination of heat, the flames should be at a tangent to the cooking vessel. This is represented by Flame Tangent in FIG. 2. The curve that permits these flames to land at it on a tangent is denoted as Vessel Contour. Since the two unknowns in calculation of this contour are φ and h, use of trigonometry gave me the radius of this curve, r, by the expression: r=((h·Cos φ)÷(1−Cos φ)). Solution to this expression gives a radius of ˜250-255 mm, implying that a vessel truncated from a perfect regular sphere of radius ˜253 mm will tangentially receive flames from gas burners, and thus achieve uniform dissemination of heat to the bottom of the cooking vessel.

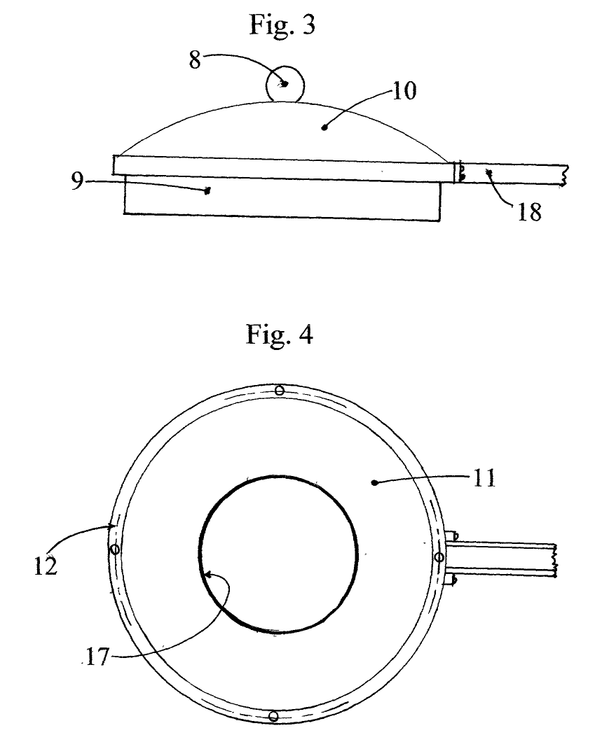

The information above is incarnated into a cooking vessel whose elevation is given in FIG. 3. This vessel has a lid 10 with holding knob 8, and a bottom portion 9. The bottom portion consists of a food-holding chamber and a cylindrical housing integrating it. A handle 18 is fastened with the bottom portion of the vessel. While on the inside, the food-holding chamber is configured incorporating the Vessel Contour of FIG. 2; on the outside, this vessel looks like any standard household cooking pan or pot. FIG. 4 shows the bottom of this vessel with a ring 11 to provide a stable resting surface on the pot when it is laid on a flat surface in kitchen. The inner hole 17 (FIG. 6) of ring 11 acts as a receptacle and chimney to the gas burner flames that tangentially enfold the vessel contour. The hot air surrounding the outside of the food-holding chamber escapes from a number of vent holes 12 along the perimeter of the bottom unit 9.

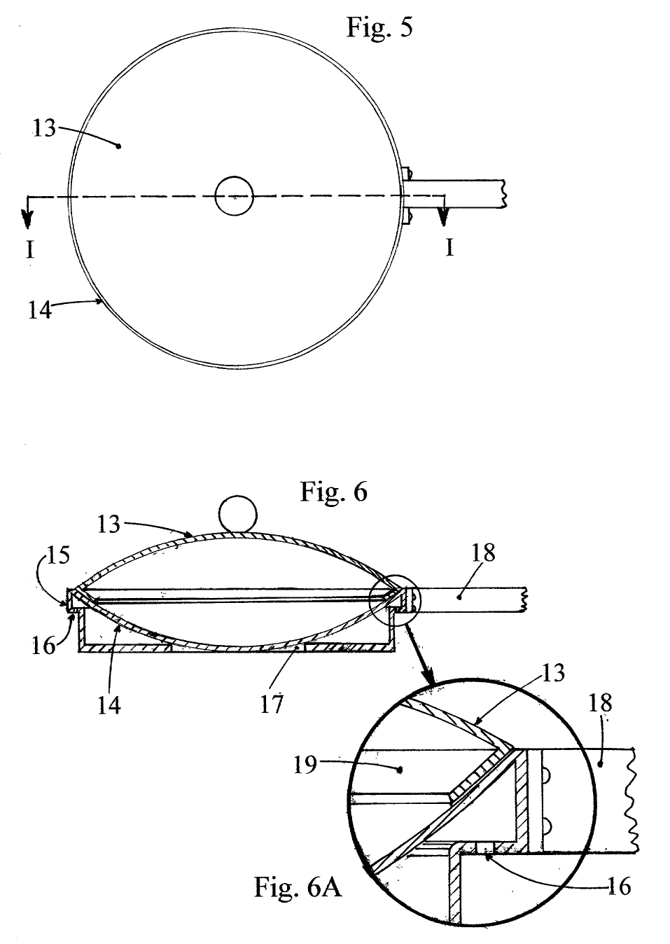

The function and construction of the Uniform Heat Disseminating Cooking Vessel is illustrated using FIG. 5 and FIG. 6. A top view of the assembled vessel is given in FIG. 5. The food-holding chamber of the vessel, configured according to the calculations of FIG. 2, is 14. To facilitate smooth transition of the flavors from the food being cooked back into it, dome 13 of the removable cover 10 has also been configured using the contour of the food-holding chamber. FIG. 6, a crosssection of the top view of FIG. 5 cut by plane I-I, illustrates this further. The sealer lip 19 (see FIG. 6A) along the perimeter of lid 10 is also configured employing the vessel contour calculated in FIG. 2. The purpose of lip 19 is to seal food flavors in the vessel for their absorption in the food, since otherwise, they will escape.

Cylindrical housing 15 is integrated with food-holding chamber 14 of Uniform Heat Dissemination Cooking Vessel. It has breather vents 16 made along the perimeter of the housing on centerline 12 (see FIG. 4). These vents serve two purposes: 1) breath in fresh air to provide oxygen for an enhanced combustion at the burner, and, 2) become escape vents for the hot spent air rising from under the food-holding chamber. Round opening 17 in the base of cylindrical housing 15 serves as flame receptacle. Flames from the gas burner go through the flame receptacle to reach outside of the food-holding chamber.

In the design of Uniform Heat Disseminating Cooking Vessel, we have a cooking utensil that permits accumulation of food being cooked at various locations on the bottom of its food-holding chamber according to the heat expected to be received there so that there is uniformity in cooking. Its design arrests flavors and moistures from the food being cooked in the food-holding chamber so that the cooked food comes out tender, juicier, and flavorful.

The description of Uniform Heat Dissemination Cooking Vessel given here embodies its most practical and obvious aspects. However, it is implicit that the invention includes all arrangements within the spirit and scope of the embodiments disclosed herein. This way, the disclosure encompasses all modifications and equivalent arrangements of this invention.

I claim:

1. A cooking vessel comprises a truncated perfect hemisphere as its food-holding chamber that is integrated with a cylindrical shaped housing providing a stable resting place with breathing vents along its periphery to allow circulation of air around flames of the burner of a gas cooking stove;
a hollow handle with a hanging hole at the opposite end of its mounting on the cylindrical housing is for grasping and moving the said cooking vessel;
a removable cover to fit open end of the said cooking vessel.

2. A spherical shape of food-holding chamber of the cooking vessel claimed in claim 1 is formed by giving it a shape as if resting on a solid angle subtended at the projected center of flames from a gas burner of a stove ranging between 120° and 140°.

3. The sphere with a radius of 230-270 mm (centered at 250 mm) at its center yields the best segment for forming the food-holding chamber of the cooking vessel.

4. A cylindrical housing integrating the spherical food-holding chamber of the cooking vessel claimed in claim 1 has vents for rising hot air from around the gas burner flame embracing the chamber.

5. A cylindrical housing claimed in claim 4 integrates a circular flat ring at its bottom providing a resting base stabilizing the vessel when laid on a flat surface.

6. A spherical segment shape of the food-holding chamber of the cooking vessel claimed in claim 2 and the cylindrical housing integrating it claimed in claim 4 are formed out of pressed sheet with stainless steel on the inside and copper on the outside.

7. A spherical segment shape of the food-holding chamber of the cooking vessel claimed in claim 2 and the cylindrical housing integrating it claimed in claim 4 are formed out of pressed sheet metals.

8. A removable cover serving as a lid on the vessel claimed in claim 1 comprises a truncated perfect hemisphere of the same geometry as the food-holding chamber claimed in claim 2.

9. A removable cover claimed in claim 8 is so formed that its circular perimeter has a diameter that defines space enclosing the spherical food-holding chamber claimed in claim 2 of the vessel claimed in claim 1.

10. A removable cover claimed in claim 8 is so formed that the lip on its inside along its diameter is a ring of the truncated hemisphere defining the food-holding chamber claimed in claim 2, creating a perfect seat for it when it sits inside the food-holding chamber.

11. A number of variations of the removable cover claimed in claim 8 are created by changing the diameter of its circular perimeter to change the enclosed space in the truncated hemispherical shaped food-holding chamber claimed in claim 2 to accommodate various quantities of food being cooked in it without having to change the cooking vessel.

12. A removable cover claimed in claim 8 is formed out of heat-resistant glass.

13. A removable cover claimed in claim 8 is formed out of pressed sheet metals.
